(19) United States
(12) Patent Application Publication
(10) Pub. No.: US 2017/0237066 A1
(43) Pub. Date: Aug. 17, 2017

(54) POSITIVE ELECTRODE ACTIVE MATERIAL FOR ALKALINE SECONDARY BATTERY AND ALKALINE SECONDARY BATTERY INCLUDING THE POSITIVE ELECTRODE ACTIVE MATERIAL

(71) Applicants: FDK CORPORATION, Tokyo (JP); FUJITSU LIMITED, Kanagawa (JP)

(72) Inventors: Yuzo Imoto, Tokyo (JP); Takeshi Ito, Tokyo (JP); Shuuichi Doi, Isehara (JP); Takashi Yamazaki, Kawasaki (JP); Yuji Kataoka, Yokohama (JP)

(21) Appl. No.: 15/433,931

(22) Filed: Feb. 15, 2017

(30) Foreign Application Priority Data
Feb. 16, 2016 (JP) 2016-027118

(51) Int. Cl. H01M 4/36; H01M 4/525; H01M 10/30; H01M 4/52

(52) U.S. Cl. CPC H01M 4/366; H01M 4/52; H01M 4/525; H01M 10/30; H01M 2004/028

(57) ABSTRACT

A nickel-hydrogen secondary battery includes an electrode group including a separator, a positive electrode, and a negative electrode, and the positive electrode includes a positive electrode active material particle including a base particle and a surface layer covering the surface of the base particle, and the base particle contains nickel hydroxide, and the surface layer contains a trivalent or higher-valent cobalt compound and Co₃O₄.

### BACKGROUND OF THE INVENTION

Field of the Invention

The present invention relates to a positive electrode active material for an alkaline secondary battery and an alkaline secondary battery including the positive electrode active material.

Description of the Related Art

Nickel-hydrogen secondary batteries are known as one of alkaline secondary batteries. Known examples of positive electrodes for such nickel-hydrogen secondary batteries include unsintered positive electrodes. Such unsintered positive electrodes are produced in the following manner, for example.

First, a nickel hydroxide particle as a positive electrode active material, a binder, and water are kneaded together to prepare a positive electrode admixture slurry, and a positive electrode base material comprising a nickel foam sheet having a porous structure is filled with the positive electrode admixture slurry. Then, an intermediate product of a positive electrode is formed through a drying process for the slurry and a rolling process to densify the positive electrode admixture. Thereafter, the intermediate product is cut in predetermined dimensions and thus an unsintered positive electrode is produced. Such unsintered positive electrodes have an advantage of allowing for filling with a positive electrode active material in a higher density than in the case of sintered positive electrodes.

Nickel hydroxide in a single substance has a low conductivity, and it is thus difficult for unsintered positive electrodes to enhance the utilization efficiency of a positive electrode active material. In view of this, a nickel hydroxide particle is typically subjected to a treatment to enhance the conductivity, and the nickel hydroxide particle with an enhanced conductivity is used. Known examples of such nickel hydroxide particles with an enhanced conductivity include a nickel hydroxide particle disclosed in Japanese Patent Laid-Open No. 10-154508. Specifically, cobalt hydroxide is precipitated on the surface of a nickel hydroxide particle and then heat-treated to convert the cobalt hydroxide on the surface of the nickel hydroxide particle into cobalt oxyhydroxide. Since cobalt oxyhydroxide is excellent in conductivity, cobalt oxyhydroxide on the surface of the nickel hydroxide particle comes into interparticle contact to form a conductive network. As a result, the conductivity of a positive electrode is enhanced, which leads to enhancement of the utilization efficiency of a positive electrode active material.

As alkaline secondary batteries are increasingly used for a wide variety of applications, the desire for enhancement of the charging efficiency has been growing. In such circumstances, containing Co in solid solution in a nickel hydroxide particle in a positive electrode active material to lower the equilibrium potential is known to improve the chargeability of a positive electrode. Improvement of the chargeability of a positive electrode leads to enhancement of the charging efficiency of a battery as a whole, and thus a nickel hydroxide particle containing a relatively large quantity of Co in solid solution is used for a positive electrode active material to obtain a battery having an excellent charging efficiency.

If a battery connected to a circuit is left to stand for a long period, the battery discharges to a voltage lower than a predetermined cut-off voltage, which is what is called deeply-discharged state.

If a battery with a positive electrode having an enhanced conductivity as described above comes into a deeply-discharged state, the potential of the positive electrode becomes equal to or lower than the reduction potential of cobalt oxyhydroxide, and as a result the cobalt oxyhydroxide forming the conductive network on the surface of the positive electrode active material is reduced. As the cobalt oxyhydroxide is reduced, the cobalt oxyhydroxide layer on the surface of the nickel hydroxide particle is partly lost and the conductive network is destroyed. As a result, the positive electrode active material cannot be utilized sufficiently and a capacity comparable to the initial capacity cannot be obtained any more even if the battery is charged again. In other words, the capacity recovery rate of the battery is lowered.

In the case that the quantity of Co contained in solid solution in the nickel hydroxide particle is large, in particular, reduction of the cobalt oxyhydroxide present on the surface of the nickel hydroxide particle tends to be accelerated, and the durability of the conductive network is lowered. For this reason, the capacity recovery rate is more likely to be lowered in the case of a battery with a nickel hydroxide particle containing a relatively large quantity of Co in solid solution as a positive electrode active material for enhancement of the charging efficiency.

As a battery repeatedly comes into a deeply-discharged state as described above, destruction of the conductive network progresses and the capacity recovery rate of the battery continues to be lowered. A battery whose capacity recovery rate has been lowered in this way cannot provide a required capacity even if the battery is charged again, which makes it difficult to normally operate electric devices or the like.

Accordingly, development of a battery having resistance to deep discharge and being capable of reducing lowering of the capacity recovery rate is desired. In particular, reduction of lowering of the capacity recovery rate is more desired for batteries having an enhanced charging efficiency as described above.

### SUMMARY OF THE INVENTION

A positive electrode active material for an alkaline secondary battery is provided, including a base particle and a surface layer covering the surface of the base particle, wherein the base particle contains nickel hydroxide, and the surface layer contains a trivalent or higher-valent cobalt compound and Co₃O₄.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a perspective view illustrating a nickel-hydrogen secondary battery according to one embodiment of the present invention by partial cutting;

FIG. 2 is a graph showing an X-ray diffraction pattern of a sample of a positive electrode active material in Example 1; and

FIG. 3 is a graph showing an X-ray diffraction pattern of a sample of a positive electrode active material in Comparative Example 1.

### DETAILED DESCRIPTION OF THE INVENTION

Hereinafter, a nickel-hydrogen secondary battery 2 according to an embodiment of the present invention (hereinafter, referred to as battery) will be described with reference to the accompanying drawings.

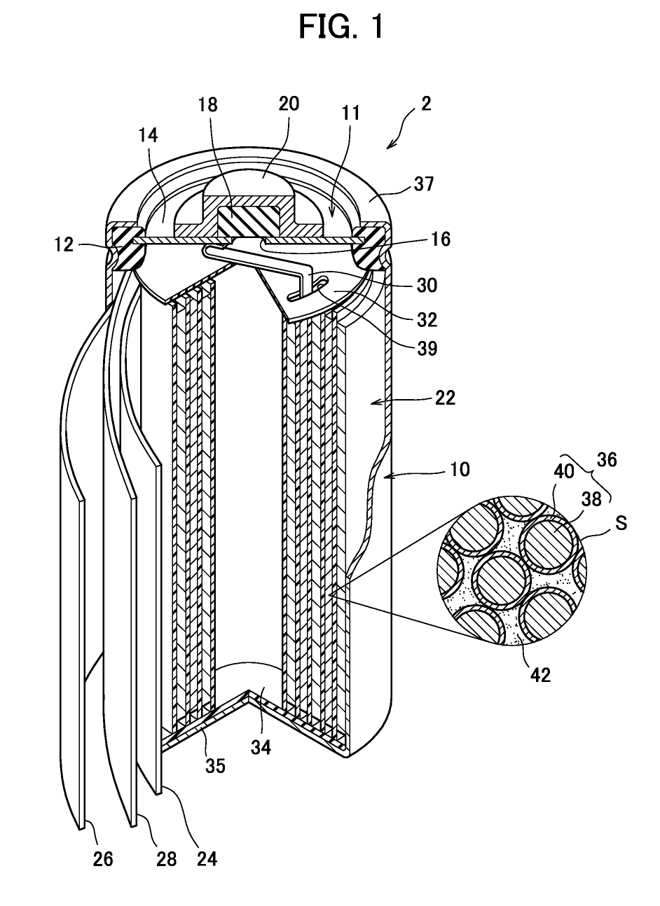

Although the battery 2 to be used for the present invention is not limited, an AA cylindrical battery 2 shown in FIG. 1 used for an embodiment the present invention will be described as an example.

As illustrated in FIG. 1, the battery 2 includes an outer can 10 having a bottomed cylindrical shape with an open top. The outer can 10 has conductivity, and its bottom wall 35 functions as a negative electrode terminal. To the opening of the outer can 10, a sealing element 11 is fixed. The sealing element 11, which includes a lid plate 14 and a positive electrode terminal 20, seals the outer can 10 and provides the positive electrode terminal 20. The lid plate 14 is a circular member having conductivity. In the opening of the outer can 10, the lid plate 14 and a ring-shaped insulation packing 12 surrounding the lid plate 14 are disposed, and the insulation packing 12 is fixed to an opening periphery 37 of the outer can 10 through caulking of the opening periphery 37 of the outer can 10. It follows that the lid plate 14 and the insulation packing 12 cooperate to airtightly block the opening of the outer can 10.

The lid plate 14 has a central through-hole 16 at its center, and a valving element 18 made of rubber to plug the central through-hole 16 is disposed on the outer surface of the lid plate 14. Onto the outer surface of the lid plate 14, the positive electrode terminal 20 having a cylindrical shape with a flange and made of metal is electrically connected in such a way as to cover the valving element 18. The positive electrode terminal 20 pushes the valving element 18 toward the lid plate 14. A degassing hole, which is not illustrated, is opened in the positive electrode terminal 20.

In normal conditions, the central through-hole 16 is airtightly closed with the valving element 18. If a gas is generated in the outer can 10 and the inner pressure increases, on the other hand, the valving element 18 is compressed due to the inner pressure to open the central through-hole 16, and as a result the gas is discharged from the outer can 10 to the outside through the central through-hole 16 and the degassing hole (not illustrated) of the positive electrode terminal 20. It follows that the central through-hole 16, the valving element 18, and the positive electrode terminal 20 serve as a safety valve for the battery.

An electrode group 22 is contained in the outer can 10. The electrode group 22 includes a positive electrode 24, a negative electrode 26, and a separator 28 each of which is band-shaped, and they are spirally wound with the separator 28 sandwiched between the positive electrode 24 and the negative electrode 26. In other words, the positive electrode 24 and the negative electrode 26 are laminated together with the separator 28 sandwiched therebetween. The outermost periphery of the electrode group 22 is formed by a part (outermost peripheral portion) of the negative electrode 26 and contacts the inner peripheral wall of the outer can 10. It follows that the negative electrode 26 and the outer can 10 are electrically connected together.

In the outer can 10, a positive electrode lead 30 is disposed between one end of the electrode group 22 and the lid plate 14. More specifically, one end of the positive electrode lead 30 is connected to the positive electrode 24 and the other end is connected to the lid plate 14. Thus, the positive electrode terminal 20 and the positive electrode 24 are electrically connected together via the positive electrode lead 30 and the lid plate 14. A circular upper insulating member 32 is disposed between the lid plate 14 and the electrode group 22, and the positive electrode lead 30 extends through a slit 39 provided in the upper insulating member 32. Similarly, a circular lower insulating member 34 is disposed between the electrode group 22 and the bottom of the outer can 10.

The outer can 10 further contains a predetermined quantity of an alkaline electrolytic solution (not illustrated) injected therein. The electrode group 22 is impregnated with the alkaline electrolytic solution, and the alkaline electrolytic solution allows chemical reaction between the positive electrode 24 and the negative electrode 26 in charging/discharging (charge/discharge reaction) to proceed. The alkaline electrolytic solution to be used is preferably an alkaline electrolytic solution containing at least one of KOH, NaOH, and LiOH as a solute.

For the material of the separator 28, for example, a polyamide nonwoven fabric or a polyolefin nonwoven fabric such as a polyethylene nonwoven fabric and a polypropylene nonwoven fabric may be used. It is preferred to impart a hydrophilic functional group to such a polyamide nonwoven fabric or polyolefin nonwoven fabric.

The positive electrode 24 includes a conductive positive electrode base material having a porous structure and a positive electrode admixture held in voids in the positive electrode base material.

For the positive electrode base material, for example, a nickel foam sheet may be used.

The positive electrode admixture contains a positive electrode active material particle 36 and a binder 42, as schematically illustrated in the circle S in FIG. 1. The binder 42 functions to bind the positive electrode active material particles 36 together, and simultaneously bind the positive electrode active material particles to the positive electrode base material. For the binder 42, for example, carboxymethyl cellulose, methyl cellulose, a PTFE (polytetrafluoroethylene) dispersion, or an HPC (hydroxypropyl cellulose) dispersion may be used.

The positive electrode active material particle 36 includes a base particle 38 and a surface layer 40 covering the surface of the base particle 38.

For the base particle 38, a nickel hydroxide particle is used. For the nickel hydroxide particle, a nickel hydroxide particle provided with a higher valence is preferably employed.

For the nickel hydroxide particle, a nickel hydroxide particle containing Co in solid solution is preferably used. The Co in solid solution contributes to enhancement of the interparticle conductivity of the positive electrode active material particles, and improves the chargeability. In this case, a small content of Co in solid solution in the nickel hydroxide particle is less effective in improving the chargeability, and in contrast an excessively high content of Co in solid solution in the nickel hydroxide particle causes inhibition of the grain growth of the nickel hydroxide particle. Accordingly, it is preferred to use a nickel hydroxide particle containing 0.5% by mass or more and 5.0% by mass or less of Co in solid solution.

It is preferred to allow the nickel hydroxide particle to further contain Zn in solid solution. In this case, Zn reduces the swelling of a positive electrode associated with progression of charge/discharge cycles and contributes to improvement of the cycle life characteristics of a battery.

The content of Zn in solid solution in the nickel hydroxide particle is preferably 3.0% by mass or more and 5.0% by mass or less based on the quantity of nickel hydroxide.

The surface layer 40 contains a trivalent or higher-valent cobalt compound and Co₃O₄. Specifically, the surface layer 40 preferably includes a high-valent cobalt compound layer comprising a cobalt compound provided with a trivalent or higher valence, and Co₃O₄ dispersed in the high-valent cobalt compound layer.

The high-valent cobalt compound layer is excellent in conductivity and forms a conductive network. For the high-valent cobalt compound layer, a layer comprising a cobalt compound provided with a trivalent or higher valence such as cobalt oxyhydroxide (CoOOH) is preferably employed.

The above-mentioned Co₃O₄ functions to prevent the trivalent or higher-valent cobalt compound, i.e., high-valent cobalt compound layer, from being reduced and reduce destruction of the conductive network even in deep discharge. Thus, Co₃O₄ contributes to providing a battery having resistance to deep discharge and being capable of reducing lowering of the capacity recovery rate.

When the positive electrode active material particle 36 according to an embodiment of the present invention is subjected to X-ray diffraction measurement by using an X-ray with a wavelength of 0.062 nm, a peak appears at a diffraction angle 20 of around 18°. The peak around 18° is derived from the (400) lattice plane of Co₃O₄. Thus, the presence of Co₃O₄ can be confirmed if a peak is present at a diffraction angle 20 of around 18°.

It is preferred to allow the surface layer 40 to further contain an alkali metal. More preferably, Na is employed for the alkali metal. Hereinafter, a cobalt compound containing Na is referred to as sodium-containing cobalt compound. More specifically, the sodium-containing cobalt compound is a compound in which Na is incorporated in a crystal of cobalt oxyhydroxide (CoOOH). It is preferred to allow a cobalt compound to contain Na as mentioned above because the homogeneity of the thickness of a surface layer 40 to be obtained increases.

Here, the homogeneity of the thickness of the surface layer refers to the degree of thickness difference between thick portions and thin portions in the surface layer. The smaller the thickness difference between thick portions and thin portions is, the higher the homogeneity is, and the larger the thickness difference between thick portions and thin portions is, the lower the homogeneity is. Typically, destruction of the conductive network tends to start at a thin portion of the surface layer. Accordingly, the higher the homogeneity of the thickness of the surface layer is, the higher the resistance to destruction of the conductive network is.

It is more preferred to allow the surface layer 40 to contain Li together with Na for the alkali metal. Specifically, a cobalt compound in which Li is incorporated in a crystal of cobalt oxyhydroxide (CoOOH) has an extremely high conductivity, and thus a proper conductive network capable of enhancing the utilization efficiency of an active material in a positive electrode can be formed.

The positive electrode active material particle 36 can be produced, for example, in the following manner

First, a nickel sulfate aqueous solution is prepared. A sodium hydroxide aqueous solution is gradually added to the nickel sulfate aqueous solution to react, and thus the base particle 38 comprising nickel hydroxide is precipitated. In the case that Co and Zn are allowed to be contained in solid solution in a nickel hydroxide particle, nickel sulfate, cobalt sulfate, and zinc sulfate are weighed so as to achieve a predetermined composition to prepare a mixed solution of them. While the mixed aqueous solution obtained is stirred, a sodium hydroxide aqueous solution is gradually added to the mixed aqueous solution to react, and thus the base particle 38 containing nickel hydroxide as a main component containing Co and Zn in solid solution is precipitated.

Then, the base particle 38 obtained is charged into an ammonia aqueous solution, and to this aqueous solution, a cobalt sulfate aqueous solution is added.

Thereby, cobalt hydroxide precipitates on the base particle 38 formed as a core, and thus a composite particle including the surface layer 40 comprising cobalt hydroxide is formed. The composite particle obtained is subjected to heat treatment in convection of air in a high temperature environment at a predetermined heating temperature for a predetermined heating duration. In the heat treatment, a temperature of 80° C. to 100° C. is preferably retained for 30 minutes to 2 hours. This heat treatment converts the cobalt hydroxide on the surface of the above composite particle into a highly-conductive cobalt compound (e.g., cobalt oxyhydroxide). If the heat treatment is kept for 70 minutes or longer, in particular, cobalt oxyhydroxide is formed and simultaneously Co₃O₄ precipitates, and thus a composite particle including the surface layer 40 comprising a highly-conductive cobalt layer containing Co₃O₄ is formed.

The thickness of the cobalt compound layer is preferably 0.1 μm or larger and 0.5 μm or smaller. In order to form a cobalt compound layer having a thickness of 0.1 μm or larger and 0.5 μm or smaller, metal Co in a quantity of approximately 2% by mass or more and 5% by mass or less based on the total mass of the base particle is required.

In the case that the surface layer 40 is allowed to contain Na, which is a preferred mode, a sodium hydroxide aqueous solution is sprayed onto the composite particle being subjected to heat treatment in convection of air in a high temperature environment. This treatment converts the cobalt hydroxide on the surface of the above composite particle to a highly-conductive cobalt compound (e.g., cobalt oxyhydroxide) and allows the cobalt hydroxide to incorporate Na therein. Thereby, the positive electrode active material particle 36 covered with the surface layer 40 comprising a cobalt compound containing Na can be obtained.

In the case of allowing the surface layer 40 to further contain Li, heat treatment is performed through spraying a lithium hydroxide aqueous solution onto the composite particle, which includes the surface layer 40 comprising a cobalt compound with Na incorporated therein as described above, placed in convection of air in a high temperature environment. Thereby, the positive electrode active material particle 36 covered with the surface layer 40 comprising a cobalt compound containing Na and Li can be obtained.

Subsequently, the positive electrode 24 is produced, for example, in the following manner

First, a positive electrode admixture slurry containing the positive electrode active material particle 36 obtained as described above, water, and the binder 42 is prepared. For example, a nickel foam sheet is filled with the positive electrode admixture slurry, and dried. After being dried, the nickel foam sheet filled with a nickel hydroxide particle, etc., is rolled and cut, and thus the positive electrode 24 is fabricated.

In the positive electrode 24 thus obtained, the positive electrode active material particle 36 comprising the base particle 38 the surface of which is covered with the surface layer 40 comes into interparticle contact as illustrated in the circle S in FIG. 1, and the surface layer 40 forms a conductive network.

It is preferred to further add at least one selected from the group comprising a Y compound, Nb compound, W compound, and Co compound, as an additive, to the positive electrode 24. The additive contributes to prevention of Co from being eluted from the surface layer 40 when deep discharge is repeated. Accordingly, addition of the additive further reduces destruction of the conductive network and improves the durability against repeated deep discharge. It is preferred to use, for example, yttrium oxide for the Y compound, to use, for example, niobium oxide for the Nb compound, to use, for example, tungsten oxide for the W compound, and to use, for example, cobalt hydroxide for the Co compound.

The additive is added into the positive electrode admixture, and the content is preferably set in the range of 0.2 parts by mass or more and 2.0 parts by mass or less based on 100 parts by mass of the positive electrode active material particle. This is because an additive content of less than 0.2 parts by mass inadequately provides an effect of preventing Co from being eluted from the surface layer 40, and an additive content of more than 2.0 parts by mass causes saturation of the effect and leads to relative reduction of the quantity of the positive electrode active material, which results in lowering of capacity.

Next, the negative electrode 26 will be described.

The negative electrode 26 includes a band-shaped, conductive negative electrode base, and a negative electrode admixture is held on the negative electrode base.

The negative electrode base comprises a sheet of a metal material with through-holes distributed therein, and for example, a punched metal sheet may be used. The negative electrode admixture fills not only the through-holes of the negative electrode base, but also is held as a layer on both surfaces of the negative electrode base.

The negative electrode admixture contains a hydrogen storage alloy particle capable of occluding/releasing hydrogen as a negative electrode active material, a conductive agent, and a binder. The binder functions to bind the hydrogen storage alloy particle and the conductive agent together, and simultaneously bind the hydrogen storage alloy particle and the conductive agent to the negative electrode base. A hydrophilic or hydrophobic polymer may be used for the binder, and carbon black or graphite may be used for the conductive agent.

The hydrogen storage alloy in the hydrogen storage alloy particle is not limited, and a hydrogen storage alloy commonly used for nickel-hydrogen secondary batteries may be employed.

The negative electrode 26 can be produced, for example, in the following manner

First, a hydrogen storage alloy powder comprising a hydrogen storage alloy particle, a conductive agent, a binder, and water are kneaded together to prepare a negative electrode admixture paste. The negative electrode admixture paste obtained is applied onto a negative electrode base and dried. After being dried, the negative electrode base with the attached hydrogen storage alloy particle, etc., is rolled and cut, and thus the negative electrode 26 is fabricated.

The positive electrode 24 and the negative electrode 26 each fabricated as described above are spirally wound with the separator 28 sandwiched therebetween, and thus the electrode group 22 is formed.

The electrode group 22 thus obtained is contained in the outer can 10. Subsequently, a predetermined quantity of an alkaline electrolytic solution is injected into the outer can 10. Thereafter, the outer can 10 containing the electrode group 22 and the alkaline electrolytic solution is sealed with the sealing element 11 provided with the positive electrode terminal 20, and thus the battery 2 according to an embodiment of the present invention can be obtained. The battery 2 obtained is subjected to initial activation treatment to make the battery ready for use.

### EXAMPLES

1. Production of battery

### Example 1

(1) Fabrication of positive electrode

Nickel sulfate, zinc sulfate, and cobalt sulfate were weighed so as to achieve a Zn content of 4.0% by mass and a Co content of 3.5% by mass each based on the quantity of Ni, and they were added to a 1 N sodium hydroxide aqueous solution containing ammonium ions to prepare a mixed aqueous solution. While the mixed aqueous solution obtained was stirred, a 10 N sodium hydroxide aqueous solution was gradually added to the mixed aqueous solution to react, and then the pH during the reaction was stabilized within 13 to 14 to produce a base particle 38 comprising a nickel hydroxide particle containing nickel hydroxide as a main component containing Zn and Co in solid solution.

The base particle 38 obtained was washed three times with pure water in a quantity 10 times as much as that of the base particle 38, and then subjected to dehydration and drying. The particle size of the base particle 38 obtained was measured with a laser diffraction/scattering particle size distribution analyzer, and the mean volume diameter (MV) of the base particle 38 was found to be 8 μm.

Subsequently, the base particle 38 obtained was charged into an ammonia aqueous solution, and a cobalt sulfate aqueous solution was added thereto while the pH during the reaction was maintained within 9 to 10.

Thereby, an intermediate product particle including a core of the base particle 38 and a cobalt hydroxide layer on the surface of the core was obtained. Here, the thickness of the cobalt hydroxide layer was approximately 0.1 μm.

Then, the intermediate product particle was placed in convection of oxygen-containing air in an environment of 80° C. The particle in convection was subjected to heat treatment for 80 minutes through spraying a 12 N sodium hydroxide aqueous solution onto the particle, by which the cobalt hydroxide on the surface of the intermediate product particle is converted into highly-conductive cobalt oxyhydroxide and simultaneously precipitation of Co₃O₄ is promoted, and Na is further incorporated in the cobalt oxyhydroxide layer, and as a result a surface layer 40 comprising cobalt oxyhydroxide containing Co₃O₄ and Na is formed. Thereafter, the particle including the cobalt oxyhydroxide layer was further placed in convection of oxygen-containing air in an environment of 80° C. The particle in convection was subjected to heat treatment for 80 minutes through spraying a 4 N lithium hydroxide aqueous solution onto the particle. The particle after the heat treatment was collected through filtration and washed with water, and then dried at 60° C. Thereby was obtained a positive electrode active material particle 36 including the surface layer 40 comprising cobalt oxyhydroxide containing Na, Li, and Co₃O₄ on the surface of the base particle 38.

Subsequently, 0.3 parts by mass of a yttrium oxide powder, 0.6 parts by mass of a niobium oxide powder, 0.2 parts by mass of HPC (hydroxypropyl cellulose), 0.2 parts by mass of a PTFE dispersion, and 50 parts by mass of ion-exchanged water were mixed with 100 parts by mass of a positive electrode active material powder comprising the nickel hydroxide particle fabricated as described above to prepare a positive electrode admixture slurry, and a sheet of nickel foam as a positive electrode base material was filled with the positive electrode admixture slurry. The nickel foam filled with the positive electrode admixture slurry was subjected to drying, and the nickel foam filled with the positive electrode admixture was then rolled. Thereafter, the nickel foam filled with the positive electrode admixture was cut in a predetermined shape to obtain a positive electrode 24 for the size AA.

### (2) Fabrication of Negative Electrode

First, a hydrogen storage alloy powder comprising an LaNi₅ particle, as an AB₅ type hydrogen storage alloy, was prepared. The particle size of the LaNi₅ particle was measured with a laser diffraction/scattering particle size distribution analyzer, and the mean volume diameter (MV) of the LaNi₅ particle was found to be 60 μm.

Subsequently, 0.4 parts by mass of a sodium polyacrylate powder, 1.0 part by mass of a carbon black powder, and 30 parts by mass of water were added to 100 parts by mass of the hydrogen storage alloy powder, and the resultant was kneaded to prepare a negative electrode admixture paste.

The negative electrode admixture paste was homogeneously applied onto both surfaces of a punched metal sheet as a negative electrode base so as to achieve a constant thickness. The punched metal sheet had a thickness of 60 μm and the surface had been nickel-plated.

After the paste was dried, the punched metal sheet holding the negative electrode admixture was rolled. Thereafter, the sheet was cut in predetermined dimensions, and thus a negative electrode 26 for the size AA was fabricated.

(3) Assembly of nickel-hydrogen secondary battery

The positive electrode 24 and negative electrode 26 obtained were spirally wound with a separator 28 sandwiched therebetween to fabricate an electrode group 22. The separator 28 used for fabrication of the electrode group 22 comprised a sulfonated polypropylene nonwoven fabric, and the thickness was 0.1 mm (basis weight: 53 g/m²).

Separately, an alkaline electrolytic solution comprising an aqueous solution containing NaOH, LiOH, and KOH was prepared. The alkaline electrolytic solution had an NaOH concentration of 5.2 N, an LiOH concentration of 1.1 N, and a KOH concentration of 1.7 N.

Then, the electrode group 22 was contained in an outer can 10 having a bottomed cylindrical shape, and a predetermined quantity of the alkaline electrolytic solution prepared was injected thereinto. Thereafter, the opening of the outer can 10 was sealed with a sealing element 11, and assembled an AA nickel-hydrogen secondary battery 2 with a nominal capacity of 2700 mAh.

Preparation of the battery 2 was duplicated: one battery was to be subjected to deep discharge under first conditions and the other battery was to be subjected to deep discharge under second conditions in measurement of the capacity recovery rate after deep discharge to be described later.

(4) Initial activation treatment

Each of the batteries 2 obtained was left to stand in an environment of 25° C. for 12 hours, and then three cycles of charging/discharging operation were performed for the battery 2, in each of which the battery 2 was charged at 0.1 C for 16 hours, and thereafter discharged at 0.2 C to a battery voltage of 1.0 V. Thereafter, each of the batteries 2 was charged at 0.1 C for 16 hours and then discharged at 1.0 C for 50 minutes, and thereafter discharged at 0.5 C until a battery voltage reached 1.0 V. By such initial activation treatment, each of the batteries 2 was made ready for use.

### Comparative Example 1

A nickel-hydrogen secondary battery was fabricated in the same manner as in Example 1 except that the heat treatment duration for the intermediate product particle was set to 45 minutes to form the surface layer 40 comprising a cobalt compound layer containing no Co₃O₄. The particle size of the base particle 38 obtained was measured with a laser diffraction/scattering particle size distribution analyzer, and the mean volume diameter (MV) of the base particle 38 was found to be 13 μm.

### 2. Evaluation of Positive Electrode Active Material and Nickel-Hydrogen Secondary Battery

### (1) X-ray Diffraction Analysis

In each of Example 1 and Comparative Example 1, a part of the positive electrode active material particle 36 fabricated had been taken in advance as a sample for X-ray diffraction analysis.

The samples were subjected to X-ray diffraction analysis with a synchrotron X-ray from a large-scaled synchrotron radiation facility (e.g., BL16XU line at Super Photon ring-8 (SPring-8)). The specific procedure is as follows.

First, a glass sample holder was filled with an appropriate quantity of a powder sample. Then, the glass sample holder filled with the sample was set on a sample stage at the rotational center of an X-ray diffractometer.

Subsequently, the sample was irradiated with an X-ray with a wavelength of 0.062 nm shaped into a size of 0.2 mm×0.2 mm Here, the glass sample holder filled with the sample was held at an angle of 5° to the incident direction of the X-ray. A diffracted X-ray emitted from the sample through a slit of 0.2 mm was measured with a scintillation detector. The scintillation detector was installed on the 20 axis of the diffractometer, and the 20 axis was scanned at a speed of 5 min/degree in the range of 10 to 40°.

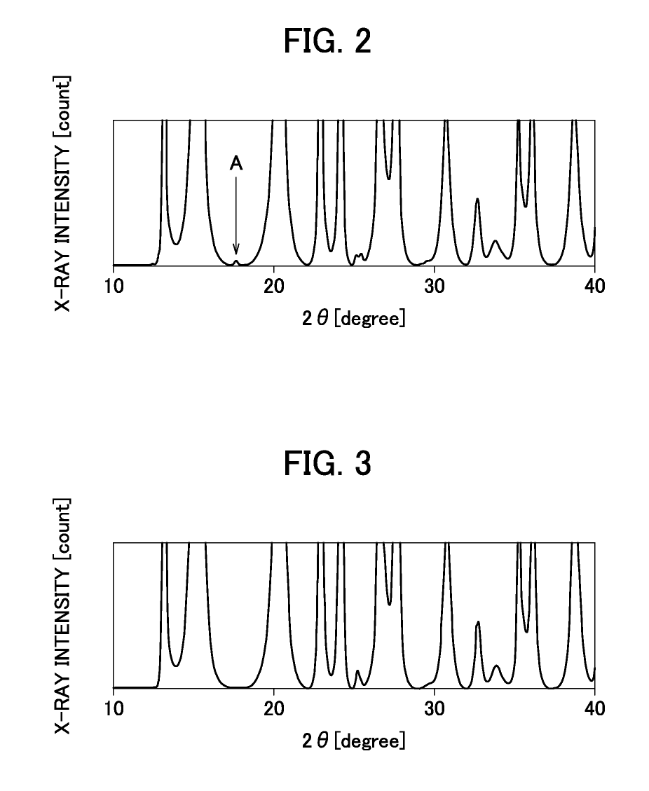

In this way, an X-ray diffraction pattern was acquired for each of the samples in Example 1 and Comparative Example 1. The graph of the X-ray diffraction pattern acquired for Example 1 and the graph of the X-ray diffraction pattern acquired for Comparative Example 1 are shown in FIG. 2 and FIG. 3, respectively.

In FIG. 2, a peak can be found at a diffraction angle 20 of around 18° for the sample in Example 1 (indicated by the arrow A). This suggests that the surface layer 40 of the positive electrode active material particle 36 in Example 1 contains Co₃O₄.

In FIG. 3, on the other hand, a peak cannot be found at a diffraction angle 20 of around 18° for the sample in Comparative Example 1. This suggests that Co₃O₄ is not present in the surface layer 40 of the positive electrode active material particle 36 in Comparative Example 1.

### (2) Measurement of Capacity Recovery Rate After Deep Discharge

The each battery after the initial activation treatment was charged in an environment of 25° C. under what is called -4V control, specifically, charged at 1.0 C until the battery voltage after having reached the maximum value was lowered by 10 mV, and then discharged at 0.2 C in the same environment until the battery voltage reached 1.0 V, and the initial capacity was determined.

Thereafter, each battery was left to stand with a resistor of 2 Ω connected to the battery for deep discharge. Here, the battery to be subjected to deep discharge under first conditions was left to stand in an environment of 60° C. for 14 days for deep discharge. For second conditions, deep discharge was performed under the first conditions, and thereafter deep discharge was further performed under the same conditions as the first conditions, i.e., the battery was left to stand in an environment of 60° C. for 14 days.

Each of the batteries after deep discharge was subjected to three charge/discharge cycles in each of which charging was performed at 1.0 C in an environment of 25° C. under -4V control and discharging was then performed at 0.2 C in the same environment until the battery voltage reached 1.0 V. And then, the capacity (capacity after deep discharge) was measured.

The capacity recovery rate after deep discharge was determined by using the following equation (I), and the results are shown in Table 1.

Capacity recovery rate after deep discharge [%]=(capacity after deep discharge/initial capacity)×100 (I)

A higher value of the capacity recovery rate after deep discharge indicates a higher resistance to deep discharge and that destruction of the conductive network is reduced.

TABLE 1

| | | Capacity recovery | |
|---|---|---|---|
| | | rate after deep | |
| | | discharge [%] | |
| | Peak at diffraction angle 2θ | Under first | Under second |
| | of 18° | conditions | conditions |
| Example 1 | present | 95.5 | 92.6 |
| Comparative | absent | 92.3 | 87.7 |
| Example 1 | | | |

### (3) Discussion

For the battery in Example 1, the capacity recovery rate after deep discharge under the first conditions is 95.5% and the capacity recovery rate after deep discharge under the second conditions is 92.6%. For the battery in Comparative Example 1, in contrast, the capacity recovery rate after deep discharge under the first conditions is 92.3% and the capacity recovery rate after deep discharge under the second conditions is 87.7%. These results confirm that the battery in Example 1 has a capacity recovery rate after deep discharge better than that of the battery in Comparative Example 1 and has an improved resistance to deep discharge in comparison with the battery in Comparative Example 1.

For the positive electrode active material particle in Example 1, the peak at a diffraction angle 20 around 18° is present and the surface layer 40 contains Co₃O₄. The Co₃O₄ prevents the cobalt compound in the surface layer 40 covering the surface of the nickel hydroxide particle form being reduced in a deeply-discharged state. Accordingly, the conductive network after deep discharge is maintained in a proper state. Thus, the battery in Example 1 is considered to have an excellent capacity recovery rate after deep discharge.

For the positive electrode active material particle in Comparative Example 1, on the other hand, the peak at a diffraction angle 20 around 18° is not present and the surface layer 40 does not contain Co₃O₄. In the positive electrode active material particle comprising the nickel hydroxide particle the surface of which is covered with the surface layer 40 in which Co₃O₄ is not present, the cobalt compound in the surface layer 40 is significantly reduced in a deeply-discharged state. Due to this, the conductive network after deep discharge is destroyed and is not maintained in a proper state. Thus, the battery in Comparative Example 1 is considered to have a capacity recovery rate after deep discharge lower than that of the battery in Example 1.

These results demonstrate that allowing the surface layer 40 of a positive electrode active material to contain Co₃O₄ is effective for formation of a battery which is less affected by deep discharge and has an excellent capacity recovery rate after deep discharge.

In Example 1 and Comparative Example 1, the nickel hydroxide particle as a base particle contains Co in solid solution in a larger quantity than in conventional cases and the charging efficiency is enhanced. In the case that the base particle contains a relatively large quantity of Co in solid solution in this way, the cobalt compound in the surface layer 40 is likely to be reduced in deep discharge. Even in such circumstances, however, the conductive network in Example 1, in which the surface layer 40 contains Co₃O₄, can be maintained in a more proper state than in the case of Comparative Example 1, in which the surface layer 40 does not contain Co₃O₄, and thus the capacity recovery rate after deep discharge in Example 1 is excellent as described above. These results demonstrate that allowing the surface layer 40 to contain Co₃O₄ is effective for formation of a battery which is less affected by deep discharge and has an excellent capacity recovery rate after deep discharge, even in the case that the base particle contains a relatively large quantity of Co in solid solution for enhancement of the charging efficiency.

The present invention is never limited to the above-described embodiments and Examples, and may be variously modified. A battery to be used for the present invention is only required to be an alkaline secondary battery, and examples thereof include, in addition to nickel-hydrogen secondary batteries, nickel-cadmium secondary batteries and nickel-zinc secondary batteries. The structure of a battery is not limited, and not only a circular battery but also a square battery may be used.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A positive electrode active material for an alkaline secondary battery, comprising a base particle and a surface layer covering a surface of the base particle, wherein:
the base particle contains nickel hydroxide, and
the surface layer contains a trivalent or higher-valent cobalt compound and Co₃O₄.

2. The positive electrode active material for an alkaline secondary battery according to claim 1, wherein:
the nickel hydroxide contains Co in solid solution.

3. The positive electrode active material for an alkaline secondary battery according to claim 2, wherein:
the nickel hydroxide contains 0.5% by mass or more and 5.0% by mass or less of Co in solid solution.

4. The positive electrode active material for an alkaline secondary battery according to claim 1, wherein:
the surface layer contains an alkali metal.

5. The positive electrode active material for an alkaline secondary battery according to claim 4, wherein:
the alkali metal is Na.

6. The positive electrode active material for an alkaline secondary battery according to claim 4, wherein:
the alkali metal is Na and Li.

7. An alkaline secondary battery comprising a container and an electrode group contained together with an alkaline electrolytic solution in the container, wherein:
the electrode group comprises a positive electrode and a negative electrode laminated with a separator sandwiched therebetween, and
the positive electrode contains the positive electrode active material for an alkaline secondary battery according to claim 1.
